(19) United States
(12) Patent Application Publication
(10) Pub. No.: US 2015/0008258 A1
(43) Pub. Date: Jan. 8, 2015

(54) WIPER BLADE DEVICE

(71) Applicant: Robert Bosch GmbH, Stuttgart (DE)

(72) Inventor: Waldemar Ernst, Vaihingen/Enz (DE)

(21) Appl. No.: 14/369,648

(22) PCT Filed: Dec. 13, 2012
(86) PCT No.: PCT/EP2012/075327

§ 371 Date: Jun. 27, 2014

(30) Foreign Application Priority Data
Dec. 27, 2011 (DE) 10 2011 089 906.5

(51) Int. Cl. G06F 17/30; G06K 19/07; G06Q 90/00; G06K 19/06

(52) U.S. Cl. CPC G06F 17/30; G06K 19/06028; G06K 19/06037; G06K 19/0723; G06Q 90/00
USPC 235/375; 235/487

(57) ABSTRACT

The invention relates to a system comprising an information carrier (10a-g), which is arranged, in particular, on a vehicle device (12b; 12d; 12f), a tool device (14c), a filter device (15g) or a packaging device (16a; 16e) of a vehicle device (12a), a tool device (14a; 14e) or a filter device (15a) and which is provided to carry at least one piece of information, and comprising a unit (18a-g), which is provided at least to receive the piece of information and to provide at least one technical service on the basis of the piece of information.

### TECHNICAL FIELD

A large number of products are available on the market which are provided only for use with certain other products. For example, many different variants of wiper arms and wiper blades are available, wherein only certain wiper blades fit to certain wiper arms. A variety of roof- or rear-mounted racks furthermore exist, which racks can, however, only be mounted on certain vehicle types. Furthermore, a certain motor oil is provided for a certain type of engine of an automobile manufacturer. In addition, attachment tools exist for hand-held power tools, such as, for example, drill bits and grinding wheels, which are provided only for use with a certain type of hand-held power tool. Finally, only certain vacuum cleaner bags fit in a certain type of vacuum cleaner. Moreover, at least somewhat fairly complex installation steps have to be carried out in particular when installing a wiper blade on a wiper arm.

### SUMMARY

The invention relates to a system comprising an information carrier which is arranged, in particular, on a vehicle device, a tool device, a filter device or a packaging device of a vehicle device, a tool device or a filter device and which is provided to carry at least one piece of information, and comprising a unit which is provided at least to receive the piece of information and to provide at least one technical service on the basis of the piece of information. The term “provided” shall be understood here and below in particular as specially programmed and/or designed and/or equipped. The information carrier is particularly provided to carry a preferably technical piece of information such that said piece of information is at least machine-readable and/or additionally machine-writable.

A “vehicle device” is particularly to be understood as a part, in particular a part subject to wear, of a vehicle, in particular a motor vehicle. The vehicle device can relate to any part of a vehicle that appears useful to the person skilled in the art, particularly to a drive unit, in particular a part of an engine, preferably a spark plug or a battery, to a transmission unit, in particular a clutch unit, to a deceleration device, in particular a brake disc or a brake lining, to exhaust equipment, in particular a catalytic converter or an exhaust pipe, to chassis equipment, in particular a shock absorber or a wheel suspension, to an illumination device, to drive equipment, in particular a rim, a tire or a wheel cover, or particularly advantageously to a wiper device, in particular a part of a wiper arm and/or a wiper blade. In addition, the vehicle device can relate to any device provided for use with a motor vehicle that appears useful to the person skilled in the art, particularly to a roof- or rear-mounted rack, preferably a luggage rack and/or a bicycle rack and/or a ski rack, to a trailer hitch and/or to tuning accessories, in particular a body component a rear spoiler or a window tinting film.

A “tool device” refers in this context particularly to a part, in particular a part subject to wear, of a tool, in particular of a preferably electrical hand-held tool and/or a preferably electrical gardening implement. The hand-held tool can relate to any hand-held tool that appears useful to the person skilled in the art, in particular a power drill, preferably an impact drill, a power screwdriver, in particular an impact screw driver, an impact hammer, a grinder, in particular an angle grinder, a milling cutter, a saw, in particular a circular saw, a blower, in particular a hot air blower, a glue gun or a pneumatic nailer. The gardening implement can relate to any gardening implement that appears useful to the person skilled in the art, in particular a lawn mower, a lawn aerator, a scarifier, a lawn trimmer, pruning shears, in particular preferably electrical pruning shears and/or preferably electrical shrub shears and/or preferably electrical hedge shears, a shredder, a pruning saw, in particular a chain saw, a garden blower, in particular a garden vacuum and/or leaf blower, or a high-pressure cleaner. In addition, the tool device can relate to an attachment to such a hand-held tool and/or gardening implement, in particular a saw blade, grinding disc, a knife or a drill bit.

A “filter device” refers in this context particularly to a part of a filter, in particular a particle filter, of a machine, in particular a vacuum cleaner. A packaging device refers in this context particularly to delivery and/or preferably sales packaging of a product.

The piece of information is preferably different from a purely economic piece of information, in particular a price. The piece of information can relate to any piece of information which appears useful to the person skilled in the art and which is preferably different from a purely economic piece of information. In a particularly advantageous manner, said piece of information relates to a piece of information which preferably unambiguously identifies a product and/or to a piece of information regarding a technical operation, in particular a set of instructions. A “technical service” is to be understood as a service which is particularly of a technical nature and is different from a pure display of a piece of information about a product which comprises the information carrier and/or the packaging device of which comprises the information carrier, in particular a display of a name of the product and/or a name of the manufacturer and/or of a piece of nutritional value information and/or a piece of information regarding additives. It is particularly to be understood by the fact that the unit is provided “to receive” the piece of information that the unit is provided to read the information carrier and/or to receive the piece of information sent out by the information carrier in particular upon request by the unit and/or also continuously.

By means of the embodiment, an ease of product use, in particular an ease of maintenance and/or assembly and/or disassembly can be advantageously promoted. In particular, a simple identification of products is facilitated with the aid of the item of information. By means of the technical service, further options promoting ease of product use can be initiated. By virtue of the fact that the information carrier is arranged on a vehicle device, a tool device or a filter device, an advantageous identification of a spare part can then also occur if an associated packaging device is no longer available.

In a preferred embodiment, the invention states that the information carrier is arranged on a surface region. The surface region particularly relates to a visible, in particular external and preferably touchable surface region. As a result, an advantageous accessibility of the information carrier is achieved.

In a particularly preferred embodiment of the invention, it is proposed that the information carrier has a visible coding, in particular a bar code and/or a 2D code. A “visible coding” is to be particularly understood in this context as a coding that is visible to the naked eye and preferably optoelectronically readable. A “bar code” refers to an optoelectronically readable font which comprises parallel lines of different width and/or dots and/or squares of varying size and gaps therebetween. The unit has in this case in particular at least one optical detection means, preferably a bar code reading device and/or a 2D code reading device and/or especially advantageously a camera. In so doing, an advantageously simple information carrier unit can be provided. In addition, proven methods of reading the information carrier unit can be utilized. In particular, a reading of the information carrier unit can take place via a camera which is already for the most part present in a mobile device. A “mobile device” is to be understood in this context as a device, preferably an end device, which is portable and thus can be used mobily due to a volume of at most 5000 cm³, in particular at a maximum of 2500 cm³, preferably of at most 1000 cm³ and especially advantageously at a maximum of 100 cm³, and/or a mass of at most 10 kg, in particular of at a maximum 5 kg, preferably at most 1 kg and especially advantageously at a maximum of 0.2 kg.

In one embodiment, the invention states that the information carrier is designed as a radio controlled information carrier. A “radio controlled information carrier” refers particularly in this context to an information carrier comprising a transponder which, in particular, gathers incoming signals and automatically answers and preferably when answering sends the piece of information out in the form of a radio signal. The radio controlled information carrier can particularly relate to an active transponder which particularly has its own energy supply. The radio controlled information carrier is, however, preferably designed as a passive transponder which draws an energy required to communicate and/or process internal processes exclusively from an electrical and/or magnetic field generated by the unit. The unit comprises in this case in particular at least one means for generating an electrical and/or magnetic field, in particular a high-frequency, electromagnetic AC field that has particularly a frequency of at least 125 kHz, preferably of at least 1 MHz and particularly advantageously of at least 300 MHz. In particular, the radio controlled information carrier can comprise a RFID chip and/or a Bluetooth transponder. As a result, a storage space of the information carrier can be arbitrarily enlarged to the greatest possible extent. In addition, data transmission can be facilitated over longer distances. Furthermore, a writing of the information carrier can be enabled.

The unit is advantageously designed as a mobile device, in particular as a tablet computer and/or smartphone. The mobile device can preferably be enhanced in the functionality thereof by means of at least one program, in particular an app. An “app” is to be understood in this case as an application for a mobile device, in particular a tablet computer and/or a smartphone, which application can be obtained, even free of cost, via an online shop integrated into an operating system of the mobile device and can thus be directly installed in the mobile device. The mobile device preferably comprises at least one first program, in particular a first app, which, when reading the information carrier and/or receiving the piece of information, controls and/or feedback controls at least one component of the mobile device and/or a special attachment for the mobile device, in particular an optical detection means, preferably a bar code reading device and/or a 2D code reading device and/or particularly advantageously a camera. The mobile device preferably comprises a second program, in particular a second app, which can be designed identically to the first program, in particular to the first app, or can, particularly in at least one operating state, be called up by the first program, in particular the first app, which provides the technical service based on the piece of information. A tablet computer refers in this context to a portable, in particular flat computer which is particularly accommodated completely in a housing of a touch screen and can be operated by finger or by pen. A “smartphone” is particularly to be understood as a mobile telephone that has at least one computer functionality, in particular an option for installing at least one program, in particular at least one app. By designing the unit as a mobile device, the unit can be made highly available and can be widely distributed. In particular, a user needs only a suitable program that can be run on the mobile device, in particular an app, in order to be able to utilize advantages of the invention. Said app could, for example, be provided free of cost to the customer and in so doing particularly create an added value that is now in demand. In addition, communication channels of the mobile device, in particular an internet access and/or a mobile phone network, can be used for the technical service, whereby the functionality thereof can be expanded, for example by a data bank that is available online. For the case that the mobile device is designed as a smartphone, a particularly advantageous operability and a particularly advantageous high availability of the unit can furthermore be achieved.

The invention further states that the piece of information identifies at least a first product. The identification is preferably unambiguous. The first product preferably relates to a vehicle device, in particular a part of a wiper arm and/or a wiper blade, a tool device and/or to a filter device. As a result, an ease of product use can be particularly advantageously increased.

In a further embodiment of the invention, it is proposed that the information carrier is arranged on a second product and/or on a packaging device of a second product; and the first product is provided for use with the second product. In this case, the first product and the second product are particularly designed differently from one another. The second product likewise preferably relates to a vehicle device, in particular a part of a wiper arm and/or a wiper blade, a tool device and/or to a filter device. By “the first product being provided for use with the second product”, it is particularly to be understood that the first product and the second product interact with one another in at least one operable state, in particular are connected to one another and/or fastened to one another and or disposed one inside the other. In so doing, a simple association of products provided for use with each other is made possible, whereby in particular an ease of product use is further increased.

If the piece of information comprises at least one product code, a piece of information identifying a product can be advantageously deposited in a manner which saves storage space. The product preferably relates to a vehicle device, in particular a part of a wiper arm and/or a wiper blade, a tool device and/or to a filter device. A “product code” refers in this context to a coding which preferably unambiguously identifies the product. The product code is preferably a product number and in particular in a machine-readable form. The piece of information can comprise particularly a plurality of product codes if an intended use of a product with at least one further product is to be indicated.

In a further embodiment of the invention, it is proposed that the piece of information comprises at least one piece of maintenance information. A piece of “maintenance information” refers in particular to a piece of information concerning maintenance, in particular a date of at least one past servicing, in particular a last servicing, and/or a date for a coming servicing, in particular the next appointed service date, and/or a type of maintenance and/or a request for maintenance. The piece of maintenance information preferably relates to a product which comprises the information carrier and/or the packaging device of which comprises the information carrier. As a result, the reliability of the product is advantageously increased. In addition, a fault diagnosis can be made easier.

The invention further states that the unit is provided at least to obtain at least one further piece of information based on the first piece of information from a data bank. In this case, the first piece of information preferably relates to at least one product code for identifying at least one product. The further piece of information likewise preferably relates to a piece of information that is different from a purely economic piece of information, in particular a price, said further piece of information relating particularly to a piece of information for completing a data set, preferably to volatile items, for example a piece of address information about a spare parts manufacturer and/or a repair shop. A “piece of address information” refers here and below particularly to at least one piece of information concerning an address, in particular at least one address data set and/or at least one piece of information about route guidance to an address. The data bank can particularly relate to a local data bank, in particular a data bank deposited in the storage unit of the unit, and/or preferably to a central data bank, in particular a data bank that can be called up via a network, preferably the internet. In this way, an amount of information can be advantageously increased, in particular to the effect that said amount of information exceeds a storage space of the information carrier. In particular, an adaptation of volatile information can be centrally performed.

In a preferred embodiment of the invention, it is proposed that the technical service comprises an output of at least assembly/mounting and/or disassembly/dismounting instructions. “Assembly/mounting and/or disassembly/dismounting instructions” refer in this context particularly to acoustic and/or visual and preferably step-by-step instructions for an assembly/mounting and/or disassembly/dismounting of a product, in particular a product which comprises the information carrier and/or the packaging device of which comprises the information carrier. The product preferably relates to a vehicle device, in particular a part of a wiper arm and/or a wiper blade, a tool device and/or a filter device. In addition, the product can relate to a further product, in particular a bicycle, which can be mounted on a vehicle apparatus, in particular a bicycle rack of a motor vehicle, on a tool device and/or on a filter device which comprises the information carrier and/or the packaging device of which comprises the information carrier. The assembly/mounting and/or disassembly/dismounting instructions preferably comprise at least one audio and/or video clip. The assembly/mounting and/or disassembly/dismounting instructions can particularly be stored in the information carrier. Said instructions are, however, preferably downloaded from a data bank. In this way, an ease of product use, in particular an ease of assembly/mounting and or disassembly/dismounting can be especially advantageously increased. In particular, even a complex assembly/mounting and or disassembly/dismounting procedure can be made easily understandable.

In a further modification to the invention, it is proposed that the technical service includes an output of at least one set of maintenance instructions. “Maintenance instructions” are particularly to be understood in this context as acoustic and/or visual and preferably step-by-step instructions for servicing a product, in particular a product which comprises the information carrier and/or the packaging device of which comprises the information carrier. The product preferably relates to a vehicle device, in particular a part of a wiper arm and/or wiper blade, a tool device and/or a filter device. The maintenance instructions preferably comprise at least one audio and/or video clip. The maintenance instructions can be stored in particular in the information carrier. Said instructions are, however, preferably downloaded from the data bank. In this way, an ease of product use, in particular an ease of maintenance, can be particularly advantageously increased. In particular, even a complex maintenance procedure can be made easily understandable.

In a particularly advantageous embodiment, the invention states that the technical service comprises at least one ordering process of at least one spare part. An “ordering process” is particularly to be understood as at least the initiation of an order, in particular a preparation of an order form, preferably to be printed out later, and/or particularly advantageously a completed order, in particular an online order, of a product. Data concerning costs and/or availability of the product to be ordered are preferably downloaded from the data bank. The product to be ordered preferably relates to a vehicle device, in particular a part of a wiper arm and/or a wiper blade, a tool device and/or a filter device. The product to be ordered can particularly relate to a spare part for a product which comprises the information carrier and/or the packaging device of which comprises the information carrier. In addition, the product to be ordered can relate to a product, in particular a spare part, which comprises the information carrier and/or the packaging device of which comprises the information carrier. Furthermore, the product to be ordered relates to a product, in particular a spare part, which is provided for use with a further product which comprises the information carrier and/or the packaging device of which comprises the information carrier. In this way, an ease of product use can be further increased in an advantageous manner. In particular, a bad buy can at least be avoided to a great extent.

The invention further states that the technical service comprises at least one display of at least one piece of address information of a spare parts manufacturer and/or a repair shop. The spare parts manufacturer and/or the repair shop particularly relate to a spare parts manufacturer and/or a repair shop for a product which comprises the information carrier and/or the packaging device of which comprises the information carrier. The piece of address information can particularly be stored in the information carrier. Said piece of address information is, however, preferably downloaded from the data bank. Said piece of address information can additionally comprise route guidance to the spare parts manufacturer and/or to the repair shop. In so doing, an ease of product use can advantageously be increased.

The technical service advantageously comprises at least one contacting of a spare parts manufacturer and/or a repair shop and/or a mobile assistance organization. By the term “contacting”, at least one establishment of contact is understood, in particular at least a dialing process of a call number and/or a sending of a message, in particular a text message and/or an e-mail. The contacting is preferably based on the piece of address information. A “mobile assistance organization” refers particularly to an organization which provides an emergency service, in particular at least a spare parts service and/or at least a repair service and/or at least a maintenance service, which at least to a great extent is available nation- or worldwide. The mobile assistance organization is preferably a part of an automobile club. In this way, a quick remedy is facilitated in the case of problems. It can particularly be ensured that contact is established with a suitable and, in particular, responsible spare parts manufacturer and/or a suitable and, in particular, responsible repair shop and/or a mobile assistance organization.

In a further embodiment of the invention, it is proposed that the technical service comprises at least one display of at least one piece of maintenance information. This relates here particularly to a piece of maintenance information for a product which comprises the information carrier and/or the packaging device of which comprises the information carrier. It is also conceivable that the information carrier automatically, in particular after a certain period of time has elapsed, initiates the display of the piece of maintenance information by the unit. It is furthermore conceivable, that the unit automatically, in particular after a certain time period has elapsed, initiates the display of the piece of maintenance information, in particular a maintenance request, after receiving the piece of information. In this way, compliance with maintenance intervals can advantageously be promoted. Furthermore, maintenance can be simplified.

The invention further states that the technical service comprises at least one display of at least one FAQ. The term “FAQ” refers in this context to a collection of answers to frequently asked questions (“Frequently Asked Questions”), in particular to frequently asked questions about a product which comprises the information carrier and/or the packaging device of which comprises the information carrier. The FAQ can particularly comprise an explanatory text and preferably also at least one audio and/or video clip. In this way, an advantageous aid can be provided to the user. In particular a usage rate of a possibly present hotline can be reduced.

The technical service advantageously comprises at least one identification of at least one second product which is provided for use with a first product. Provision can therefore especially be made for the information carrier to be arranged on the first product and particularly for the piece of information carried by said first product to comprise an identification of said first product. The technical service can then comprise an identification of a second product which is provided for use with the first product. This can on the one hand take place such that the information carrier carries this piece of information. Preferably the fact is however ascertained from the data bank, which second product is provided for use with the first product. It is in particular even conceivable that the second product or the packaging device thereof also comprises a further information carrier, the piece of information of which can then be received at a dealer by means of the unit, wherein the unit informs a user as to whether the second product, which comprises the further information carrier and/or the packaging device of which comprises the further information carrier, is suitable for use with the first product. In this way, an ease of product use can be especially advantageously increased because a simple identification of products to be used with each other can result by means of the unit.

In a further embodiment, the invention states that the piece of information can be changed. By virtue of the fact that the piece of information “can be changed”, it is to be understood that, after a delivery of a product which comprises the information carrier and/or the packaging device of which comprises the information carrier, the information carrier is at least partially writable, in particular if the piece of information comprises an item of maintenance information. A writing of the information carrier can particularly take place by means of further components of a vehicle, a tool or a filter unit. The writing, however, preferably takes place by means of the unit and preferably by initiation of the user. In this case, the information carrier is preferably designed as a radio controlled information carrier which comprises at least one semi-permanent storage unit, in particular an EEPROM or a flash EEPROM. In this way, the functionality can be advantageously expanded. Thus, a piece of maintenance information, in particular the last service date, can be written into the information carrier. In addition, a day of an assembly of a product can be written into the information carrier, which day can preferably be disposed on the product itself and/or on the packaging device thereof.

If the unit is provided to at least change the piece of information, an ease of product use can be advantageously increased. The unit particularly comprises a specially designed writing unit which allows a writing of the information carrier. In this case, the information carrier is preferably embodied as a radio controlled information carrier and/or as a Bluetooth transponder and the unit comprises a correspondingly designed writing unit.

A method is further proposed for operating a system comprising an information carrier, which is, in particular, directly arranged on a vehicle device, a tool device, a filter device or a packaging device of a vehicle device, a tool device or a filter device and which carries at least one piece of information, in which method the piece of information is received and at least one technical service is provided on the basis of the piece of information.

Furthermore, an information carrier of such a system is proposed.

In addition, a vehicle device, in particular a wiper device, a tool device, in particular a grinding disc, cutting disc, a saw blade or a drill bit, and a packaging device, in particular of a vehicle device and or a tool device, comprising an information carrier of such a system are proposed.

### BRIEF DESCRIPTION OF THE DRAWINGS

Further advantages ensue from the following description of the drawings. Exemplary embodiments of the invention are depicted in the drawings. The drawings, the description and the claims contain numerous features in combination. The person skilled in the art will also expediently consider the features in isolation and put them together to form further useful combinations.

In the drawings:

FIG. 1 shows a system comprising an information carrier, which is arranged on a packaging device of a vehicle device, a tool device or a filter device and is designed as a bar code, and comprising a unit designed as a smartphone;

FIG. 2 shows a vehicle device designed as a wiper blade and comprising an information carrier in the form of a 2D code;

FIG. 3 shows a tool device embodied as a grinding disc and comprising an information carrier in the form of a bar code;

FIG. 4 shows a vehicle device designed as a wiper blade and comprising an information carrier in the form of a 2D code;

FIG. 5 shows a packaging device of a tool device comprising an information carrier in the form of a bar code;

FIG. 6 shows a vehicle device designed as a wiper arm and comprising a radio controlled information carrier;

FIG. 7 shows a vacuum cleaner comprising a filter device, which has an information carrier in the form of a bar code; and

FIG. 8 shows a flow diagram of an app running on the smart phone.

### DETAILED DESCRIPTION

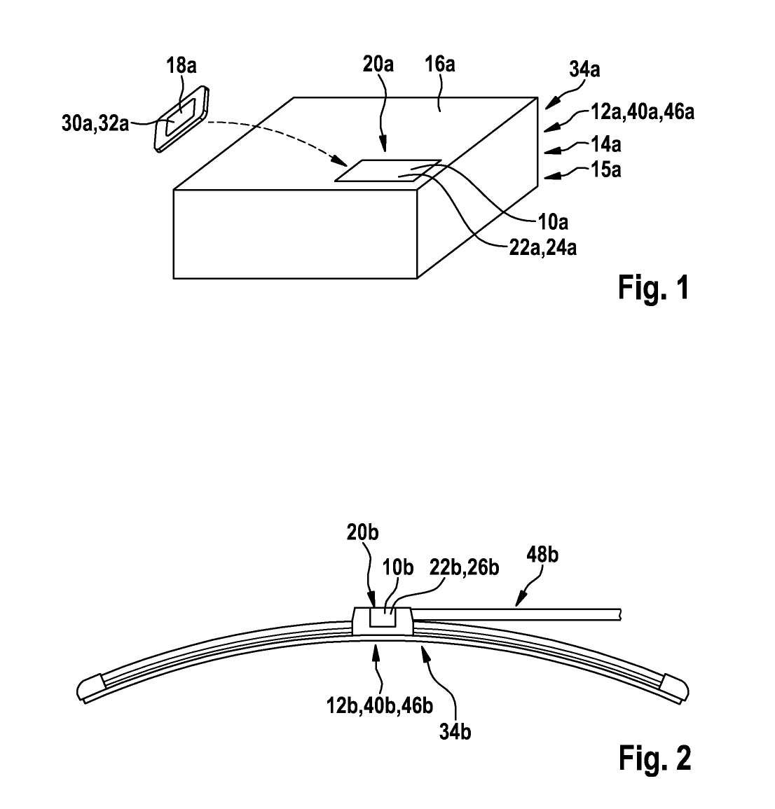

FIG. 1 shows a system comprising an information carrier 10a, which is arranged on a packaging device 16a and which is provided to carry at least one piece of information, and comprising a unit 18a which is provided to receive the piece of information and to provide a technical service on the basis of said piece of information. The packaging device 16a can relate to any packaging device 16a that appears useful to the person skilled in the art of a vehicle device 12a, for example of a wiper device 40a designed as a wiper blade 46a, a tool device 14a or a filter device 15a. The packaging device 16a can be a delivery packaging device or also a sales packaging device. The information carrier 10a is arranged on a surface region 20a of the packaging device 16a, for example glued or imprinted thereupon. The information carrier 10a comprises a visible coding 22a. The visible coding 22a comprise a bar code 24a. The piece of information coded in the bar code serves to identify a product 34a contained in the packaging device 16a and namely the vehicle device 12a, the tool device 14a or the filter device 15a. The bar code 24a can relate to a bar code on the basis of the UPC and/or EAN-13 standards that is widely used in retail trade. By means of the bar code 24a, a product code of the product 34a contained in the packaging device 16a is coded. As an alternative or in addition to the bar code 24a, an information carrier can also be any other visible coding that appears useful to the person skilled in the art. It is furthermore conceivable that an information carrier is designed as a radio controlled information carrier. The unit 18a is designed as a mobile device 30a and namely as a smartphone 32a. A special app, with the help of which the information carrier 10a can be read out, is installed on the mobile device 30a. The mobile device 30a comprises a camera (not depicted) with the help of which the visible coding 22a can be read in order to then be processed by the app.

In FIGS. 2 to 7, further exemplary embodiments of the invention are shown. The following descriptions are limited substantially to the differences between the exemplary embodiments, wherein, with regard to unchanging components, features and functions, reference can be made to the description of the other exemplary embodiments, in particular to FIG. 1. In order to differentiate the exemplary embodiments, the letter a in the reference signs of the exemplary embodiment in FIG. 1 is replaced by the letters b-g in the reference signs of the exemplary embodiments of FIGS. 2 to 7. In regard to identically denoted components, in particular in regard to components having the same reference signs, reference can also in principle be made to the figures and/or the description of the other exemplary embodiments, in particular the embodiment of FIG. 1.

FIG. 2 shows a vehicle device 12b designed as a wiper device 40b. The wiper device 40b relates to a wiper blade 46b. The vehicle device 12b comprises an information carrier 10b. The information carrier 10b is arranged in a surface region 20b of the vehicle device 12b. The information carrier 10b comprises a visible coding 22b. The visible coding 22b comprises a 2D code 26b. The piece of information coded in the 2D code serves to unambiguously identify the vehicle device 12b. A product code of the vehicle device 12b is coded by means of the 2D code 26b. As an alternative or in addition to the 2D code 26b, an information carrier can also comprise any other visible coding that appears useful to the person skilled in the art. It is furthermore conceivable for the information carrier to be designed as a radio controlled information carrier.

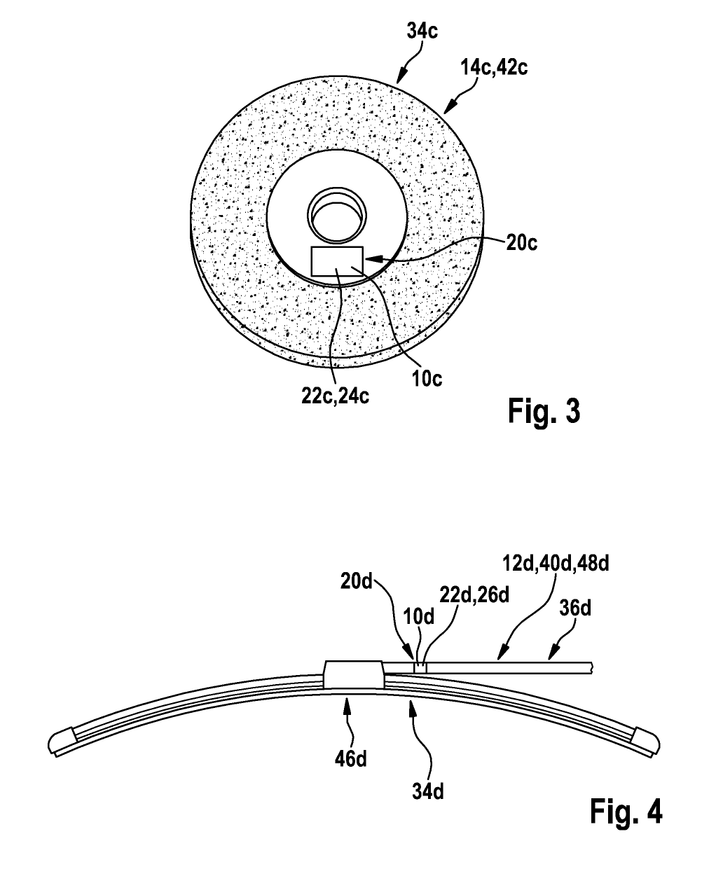

FIG. 3 shows a tool device 14c that is designed as a grinding disc 42c. The tool device 14c comprises an information carrier 10c. The information carrier 10c is arranged in a surface region 20c of the tool device 14c. The information carrier 10c comprises a visible coding 22c. The visible coding 22c comprises a bar code 24c. The piece of information coded in the bar code 24c serves to unambiguously identify the tool device 14c. A product code of the tool device 14c is coded using the bar code 24c. As an alternative or in addition to the bar code 24c, an information carrier can also comprise any other visible coding that appears useful to the person skilled in the art. It is furthermore conceivable for an information carrier to be designed as a radio controlled information carrier.

FIG. 4 shows a vehicle device 12d designed as a wiper device 12d. The wiper device 40d relates to a wiper arm 48d. The vehicle device 12d comprises an information carrier 10d. The information carrier 10d is arranged in a surface region 20d of the vehicle device 12d. The information carrier 10d comprises a visible coding 22d. The visible coding 22d comprises a 2D code. The piece of information coded in the 2D code identifies on the one hand the wiper arm 48d and on the other hand a wiper blade 46d which is compatible with the wiper arm 48d and is provided for use with said wiper arm 48d. A product code of the wiper arm 48d and a product code of the wiper blade 46d are coded using the 2D code 26d. As an alternative or in addition to the 2D code 26d, an information carrier can also comprise any other visible coding that appears useful to the person skilled in the art. It is furthermore conceivable for an information carrier to be designed as a radio controlled information carrier.

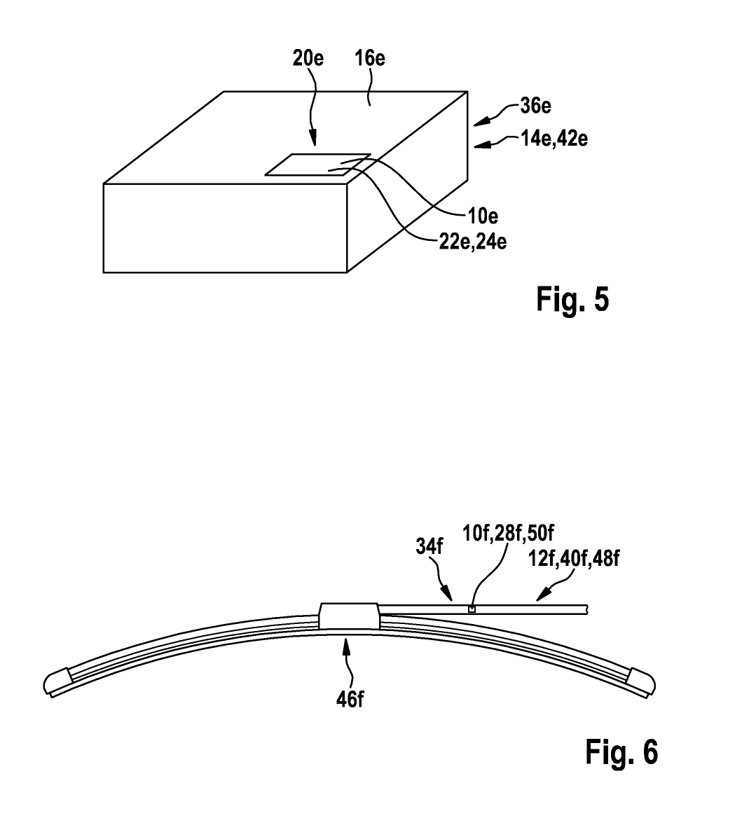

FIG. 5 shows a packaging device 16e of a tool device 14e. The tool device 14e relates to a grinding disc 42e. The packaging device 16e comprises an information carrier 10e. The information carrier 10e is arranged in a surface region 20e. The information carrier 10e comprises a visible coding 22e. The visible coding 22e comprises a bar code 24e. The piece of information coded in the bar code 24e identifies on the one hand the tool device 14e and on the other hand a machine tool compatible with the tool device 14e, in this case an angle grinder (not depicted) that is compatible with the grinding disc 42e. A product code of the tool device 14e and a product code of the machine tool are coded using the bar code 24e. As an alternative or in addition to the bar code 24e, an information carrier can also comprise any other visible coding that appears useful to the person skilled in the art. It is furthermore conceivable for the information carrier to be designed as a radio controlled information carrier.

FIG. 6 shows a vehicle device 12f designed as a wiper device 40f. The wiper device 40f relates to a wiper arm 48f. The vehicle device 12f comprises an information carrier 10f. The information carrier 10f is disposed in an interior region of the wiper arm 48f. The information carrier 10f can also alternatively be arranged in a surface region of the wiper arm 48f. The information carrier 10f is designed as a radio controlled information carrier 28f. The radio controlled information carrier 28f comprises a Bluetooth transponder 50f. A radio controlled information carrier can also alternatively or additionally comprise a RFID chip. The radio controlled information carrier 28f comprises a semi-permanent storage unit in which a piece of information is deposited. The piece of information can at least partially be changed. The piece of information relates to an identification of the wiper arm 48f, to an identification of a wiper blade 46f that is compatible with the wiper arm 48f and to a piece of maintenance information. The piece of maintenance information relates to the day of installation of the wiper blade 46f. Said day of installation is written, immediately after an installation of the wiper blade 46f onto the wiper arm 48f, by means of a smartphone 32f into a storage area of the storage unit provided for this purpose. Any piece of information appearing useful to the person skilled in the art can alternatively or additionally be deposited in the information carrier 1 Of, in particular the next service date. A mobile device 30f for reading the radio controlled information carrier 28f comprises a Bluetooth interface (not depicted).

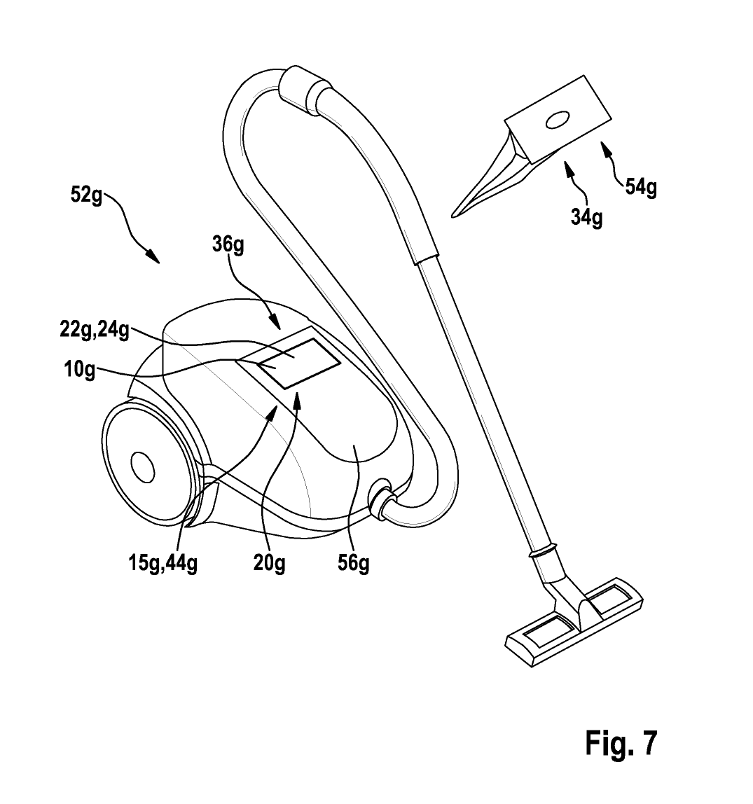

FIG. 7 shows a vacuum cleaner 52g comprising a filter device 15g designed as a vacuum cleaner device 44g. The filter device 15g comprises a receiving area for a filter bag 54g. The receiving area can be closed by a cover flap 56g. The filter device 15g comprises an information carrier 10g. The information carrier 10g is disposed in a surface region 20g of the cover flap 56g. The information carrier 10g comprises a visible coding 22g. The visible coding 22g comprises a bar code 24g. The piece of information coded in the bar code 24g identifies on the one hand the filter device 15g and on the other hand the filter bag 54g that is compatible with the filter device 15g. A product code of the filter device 15g and a product code of the filter bag 54g are coded using the bar code 24g. As an alternative or in addition to the bar code 24g, an information carrier can comprise any other visible code that appears useful to the person skilled in the art. It is furthermore conceivable for the information carrier to be designed as a radio controlled information carrier.

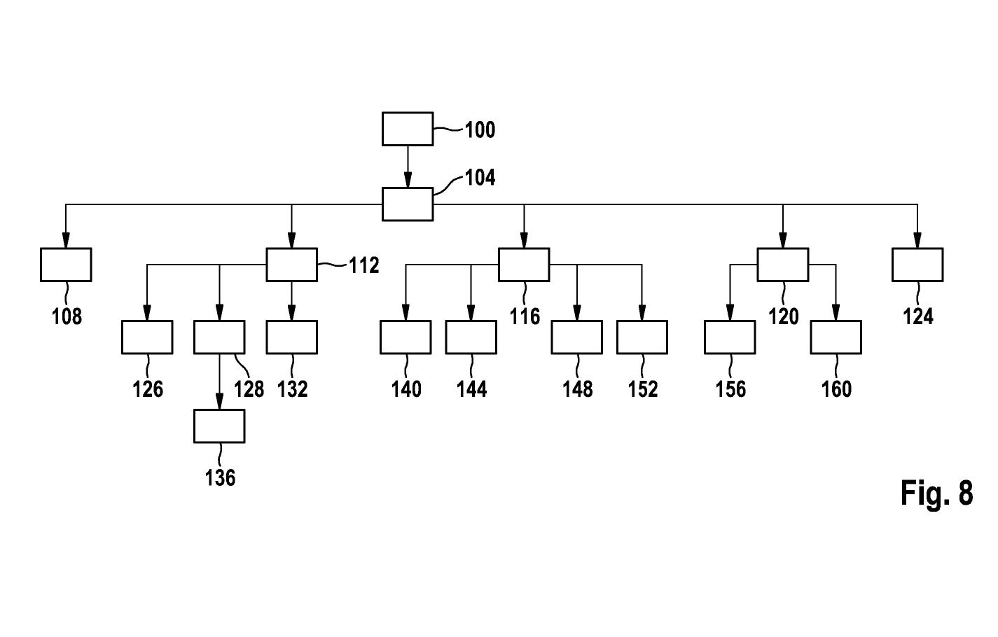

FIG. 8 shows a schematic depiction of a menu structure and of an associated program sequence of the app for the mobile devices 30a-g, said app being provided for reading out the piece of information from the information carriers 10a-g and for providing a technical service based on said piece of information. After a start-up of the app, a user is requested by means of an operating request 100 to read out the information carrier 10a-g. In the case of visible codings 22a-e; 22g, said read-out takes place by means of the camera of the mobile device 30a-e; 30g. On the other hand, said read-out takes place via the Bluetooth interface of the mobile device 30f in the case of the radio controlled information carrier 28f comprising the Bluetooth transponder 50f.

After the information carrier 10a-g has been read out, an identification of the vehicle device 12a; 12b; 12d; 12f, the tool device 14a; 14c; 14e or the filter device 15a; 15g which comprises the information carrier 10b-d; 10f; 10g or the packaging device 16a; 16e of which comprises the information carrier 10a; 10e is displayed on a main monitor on the basis of the product code deposited in the information carriers 10a-g. Provision can additionally be made for further items of information to be displayed which are downloaded in particular via a data bank. In so doing, safety guidelines are worth considering which are to be observed when using the vehicle device 12a; 12b; 12d; 12f, the tool device 14a; 14c; 14e or the filter device 15a; 15g. The safety guidelines can particularly comprise a video or audio clip. The data bank can relate to a local data bank stored on the mobile device 30a-g. The data bank is, however, preferably an online data bank that is available over the internet. A menu together with the depicted pieces of information is displayed to the user. The menu is accordingly adapted to the respective requirements and contains, in particular, only such menu items that are useful with regard to a given vehicle device 12a; 12b; 12d; 12f, the tool device 14a; 14c; 14e or the filter device 15a; 15g. The menu items relate to the following: a menu item 108 “assembly/mounting”, a menu item 112 “repair and spare parts”, a menu item 116 “compatible products”, a menu item 120 “maintenance” and a menu item 124 “FAQ”. Particularly the menu item 120 “maintenance” can be omitted with certain products.

By selecting the menu item 108 “assembly/mounting”, assembly/mounting instructions are displayed to the user for assembling/mounting the vehicle device 12a; 12b; 12d; 12f, the tool device 14a; 14c; 14e or the filter device 15a; 15g. The assembly/mounting instructions comprise a video clip. Assembly/mounting instructions can also alternatively or additionally comprise detail drawings and/or an audio clip. It is furthermore conceivable for disassembly/dismounting instructions to be available. The assembly/mounting and/or disassembly/dismounting instructions are thereby downloaded from the data bank. It is also alternatively or additionally conceivable for the assembly/mounting and/or disassembly/dismounting instructions to be stored on an information carrier. An application which is different from the app and is available on the mobile device 30a-g can also, in particular, be used for a playback of the assembly/mounting and/or disassembly/dismounting instructions. The user can at any time interrupt or fast forward and rewind the playback. The user can also play the playback faster and slower and also completely exit said playback

By selecting the menu item 112, “repair and spare parts”, a submenu relating to a repair of and/or spare parts for the vehicle device 12a; 12b; 12d; 12f, the tool device 14a; 14c; 14e or the filter device 15a; 15g is displayed to the user. The submenu items relate to the following: a submenu item 126 “order”, a submenu item 128 “addresses” and a submenu item 132 “contact”.

By selecting the submenu item 126 “order”, the user can initiate an ordering process for the vehicle device 12a; 12b; 12d; 12f, the tool device 14a; 14c; 14e or the filter device 15a; 15g, for example fill out an order form and later print out the same, or directly place an order for the product, in particular online via the internet. Under the submenu item 126, the user furthermore receives ordering information with regard to price and/or availability and/or an anticipated delivery time of the product. The ordering information is downloaded from the data bank or a data bank of a dealer. It is also alternatively or additionally conceivable for said information to be at least partially stored on an information carrier.

By selecting the submenu item 128 “addresses”, a list of dealers and/or repair shops is displayed to the user, which offers the sale of the vehicle device 12a; 12b; 12d; 12f, the tool device 14a; 14c; 14e or the filter device 15a; 15g and/or the performance of repairs to said vehicle device 12a; 12b; 12d; 12f, said tool device 14a; 14c; 14e or said filter device 15a; 15g. The list of the dealers and/or repair shops is downloaded from the data bank. The list is preferably sorted in such a manner that the user is first shown the nearest dealers and/or repair shops. By selecting one of the dealers or one of the repair shops, the user can immediately start up a route guidance 136. The route guidance 136 can also particularly be provided by an application that is different from the app and available on the mobile device 30a-g.

By selecting the submenu item 132 “contact”, the user is likewise displayed a list of dealers and/or repair shops which offers the sale of the vehicle device 12a; 12b; 12d; 12f, the tool device 14a; 14c; 14e or the filter device 15a; 15g and/or the performance of repairs to said vehicle device 12a; 12b; 12d; 12f, said tool device 14a; 14c; 14e or said filter device 15a; 15g. In addition, mobile assistance organizations, for example a mobile assistance organization of an automobile club, are provided to the user for selection. The list of the dealers and/or repair shops and/or mobile assistance organizations is downloaded from the data bank. When selecting a dealer, a repair shop or a mobile assistance organization, the user can directly make contact with the dealer, repair shop or mobile assistance organization, in particular via telephone as well as via e-mail or text message. When contacting by e-mail or text message, the product identification of the vehicle device 12a; 12b; 12d; 12f, the tool device 14a; 14c; 14e or the filter device 15a; 15g is directly transferred into the message as a text block.

By selecting the menu item 116 “compatible products”, a product compatible with the vehicle device 12a; 12b; 12d; 12f, the tool device 14a; 14c; 14e or the filter device 15a; 15g or, for the case where a plurality of compatible products exist, a corresponding list of said products is displayed to the user. A product code of the compatible product or product codes of the compatible products are, in the case of the information carriers 10d-g, stored on the same. In the case of the information carriers 10a-c, the product code of the compatible product or the product codes of the compatible products are downloaded via the data bank. Further pieces of information with regard to the compatible product or the compatible products are likewise downloaded from the data bank. For each of the compatible products displayed, the user can select further functions from a submenu. The submenu items relate to the following: a submenu item 144 “order”, a submenu item 148 “assembly/mounting” and a submenu item 152 “FAQ”. In addition, the user can select a product-independent submenu item 140 “scan identification”.

By selecting the submenu item 140 “scan identification”, the user can determine whether a further product is compatible with the vehicle device 12a; 12b; 12d; 12f, the tool device 14a; 14c; 14e or the filter device 15a; 15g by reading out a further information carrier which is arranged on the further product and/or on the packaging device thereof. A request to read out the further information carrier is displayed to the user. After reading out the further information carrier of the further product, the user is informed, in particular acoustically and/or preferably optically, whether the further product is compatible with the vehicle device 12a; 12b; 12d; 12f, the tool device 14a; 14c; 14e or the filter device 15a; 15g. To this end, the app compares the product identification of the further product, which was read out, to a list of products compatible with said vehicle device 12a; 12b; 12d; 12f, said tool device 14a; 14c; 14e or said filter device 15a; 15g. The list can be stored on the information carrier 10a-g. Said list is, however, preferably downloaded from a data bank. Furthermore, additional information with regard to the further product can be displayed to the user, in particular a piece of price information. Said additional information can at least partially be downloaded from the data bank.

By selecting the submenu item 144, “order”, the user can initiate an ordering process for the product compatible with the vehicle device 12a; 12b; 12d; 12f, the tool device 14a; 14c; 14e or the filter device 15a; 15g, for example filling out and later printing out an order form, or directly placing an order of the product, in particular online via the internet. Under the submenu item 144, the user furthermore receives ordering information regarding price and/or availability and/or an anticipated delivery time of the product. The ordering information is downloaded from the data bank or from a data bank of a dealer. It is also alternatively or additionally conceivable for said information to be stored at least partially on an information carrier.

By selecting the submenu item 148 “assembly/mounting”, assembly/mounting instructions for assembling/mounting the product compatible with the vehicle device 12a; 12b; 12d; 12f, the tool device 14a; 14c; 14e or the filter device 15a; 15g to/on said vehicle device 12a; 12b; 12d; 12f, said tool device 14a; 14c; 14e or said filter device 15a; 15g are displayed. Assembly/mounting instructions can also comprise detail drawings and/or an audio clip. It is furthermore conceivable for disassembly/dismounting instructions to also be available. The assembly/mounting and/or disassembly/dismounting instructions are thereby downloaded from the data bank. It is also alternatively or additionally conceivable for the assembly/mounting and/or disassembly/dismounting instructions to be stored on the information carrier. An application which is different from the app and is available on the mobile device 30a-g can also, in particular, be used for a playback of the assembly/mounting and/or disassembly/dismounting instructions. The user can at any time interrupt or fast forward and rewind the playback. The user can also play the playback faster and slower and also completely exit said playback.

By selecting the submenu item 152 “FAQ”, a list of answers to frequently asked questions about the product compatible with the vehicle device 12a; 12b; 12d; 12f, the tool device 14a; 14c; 14e or the filter device 15a; 15g is provided. The questions can relate to any questions that appear useful to the person skilled in the art, for example questions regarding environmental impact, disposal, dangers during operation or compatibility. The questions and the associated answers are thereby downloaded from the data bank. It is also alternatively or additionally conceivable for said questions and associated answers to be at least partially stored on an information carrier.

If the menu item 120 “maintenance” is selected, a piece of maintenance information is displayed to the user. The piece of maintenance information can relate to any maintenance information that appears useful to the person skilled in the art, in particular a date of a last servicing and/or a maintenance request, such as, for example, “filter change” and/or “wiper blade change”. The menu item 120 is particularly useful with an information carrier 10f which is designed as a radio controlled information carrier 28f and is at least partially writable. As a result, corresponding pieces of maintenance information, in particular the date of the last servicing, can be written by means of the mobile device 30f into the radio controlled information carrier 28f. In addition, a submenu comprising various entries regarding maintenance is displayed to the user. The submenu items relate to the following: a submenu item 156 “care instructions” and a submenu item 160 “maintenance instructions”.

By selecting the submenu item 156 “care instructions”, care instructions for care, in particular cleaning, of the vehicle device 12a; 12b; 12d; 12f, the tool device 14a; 14c; 14e or the filter device 15a; 15g are displayed to the user. The care instructions comprise a video clip. The care instructions can alternatively or additionally include detail drawings and/or an audio clip. In so doing, the care instructions are downloaded from the data bank. It is also alternatively or additionally conceivable for the care instructions to be stored on an information carrier. An application which is different from the app and is available on the mobile device 30a-g can also, in particular, be used for a playback of the care instructions. The user can at any time interrupt or fast forward and rewind the playback. The user can also play the playback faster and slower and also completely exit said playback.

If the submenu item 160 “maintenance instructions” is selected, maintenance instructions for a servicing, in particular for a filter change, of the vehicle device 12a; 12b; 12d; 12f, the tool device 14a; 14c; 14e or the filter device 15a; 15g are displayed to the user. The maintenance instructions comprise a video clip. The maintenance instructions can alternatively or additionally include detail drawings and/or an audio clip. The maintenance instructions are thereby downloaded from the data bank. It is alternatively or additionally conceivable for the maintenance instructions to be stored on an information carrier. An application which is different from the app and is available on the mobile device 30a-g can also, in particular, be used for a playback of the maintenance instructions. The user can at any time interrupt or fast forward and rewind the playback. The user can also play the playback faster and slower and also completely exit said playback.

By selecting the menu item 124 “FAQ”, a list of answers to frequently asked questions about the vehicle device 12a; 12b; 12d; 12f, the tool device 14a; 14c; 14e or the filter device 15a; 15g is provided to the user. The questions can relate to any questions that appear useful to the person skilled in the art, for example questions regarding environmental impact, disposal, dangers during operation or compatibility. The questions and the associated answers are thereby downloaded from the data bank. It is also alternatively or additionally conceivable for said questions and associated answers to be at least partially stored on an information carrier.

In an alternative embodiment, it is conceivable for a unit to be provided to read out an information carrier of a product, which comprises the information carrier and/or the packaging device of which comprises the information carrier, and to program itself on the basis of the piece of information. Hence, the unit can, for example, be designed as a hand-held power tool, in particular an angle grinder or a drill, and the product as an attachment, in particular a grinding or cutting disc or a drill bit. The attachment comprises the information carrier, in particular an RFID chip which can be read by the hand-held power tool. The information transmitted in the process can, for example, comprise a maximum admissible rotational speed and/or maximum admissible torque for the attachment. The hand-held power tool takes these limit values into account when operating the attachment.

1. A system comprising an information carrier (10a-g) which is arranged on a vehicle device (12b; 12d; 12f), a tool device (14c), a filter device (15g) or a packaging device (16a; 16e) of a vehicle device (12a), a tool device (14a; 14e) or a filter device (15a) and which is provided to carry at least one piece of information, and comprising a unit (18a-g) which is configured to receive the piece of information and to provide at least one technical service on the basis of said piece of information.

2. The system according to claim 1, characterized in that the information carrier (10a-e; 10g) is arranged on a surface region (20a-e; 20g).

3. The system according to claim 1, characterized in that the information carrier (10a-e; 10g) comprises at least one visible coding (22a-e; 22g).

4. The system according to claim 1, characterized in that the information carrier (10f) is a radio controlled information carrier (28f).

5. The system according to claim 1, characterized in that the unit (18a-g) is a mobile device (30a-g).

6. The system according to claim 1, characterized in that the piece of information identifies at least a first product (34a-g).

7. The system according to claim 6, characterized in that the information carrier (10d; 10e; 10g) is arranged on a second product (36d; 36g) and/or on a packaging device (16e) of a second product (36e) and the first product (34d; 34e; 34g) is configured for use with the second product (36d; 36e; 36g).

8. The system according to claim 6, characterized in that the piece of information comprises at least one product code.

9. The system according to claim 1, characterized in that the piece of information comprises at least one piece of maintenance information.

10. The system according to claim 1, characterized in that the unit (18a-g) is configured to obtain at least one further piece of information from a data bank on the basis of the first piece of information.

11. The system according to claim 1, characterized in that the technical service comprises an output of at least one set of assembly/mounting instructions and/or disassembly/dismounting instructions.

12. The system according to claim 1, characterized in that the technical service comprises an output of at least one set of maintenance instructions.

13. The system according to claim 1, characterized in that the technical service comprises at least one ordering process for at least one spare part.

14. The system according to claim 1, characterized in that the technical service comprises at least one display of at least one piece of address information about a spare parts manufacturer and/or a repair shop.

15. The system according to claim 1, characterized in that the technical service comprises at least one contacting of a spare parts manufacturer and/or a repair shop and/or a mobile assistance organization.

16. The system according to claim 1, characterized in that the technical service comprises at least one display of at least one piece of maintenance information.

17. The system according to claim 1, characterized in that the technical service comprises at least one display of at least one FAQ.

18. The system according to claim 1, characterized in that the technical service comprises at least one identification of at least one second product (36d; 36e; 36g) which is configured for use with a first product (34d; 34e; 34g).

19. The system according to claim 1, characterized in that the piece of information can be changed.

20. The system according to claim 19, characterized in that the unit (18f) is provided at least to change the piece of information.

21. A method for operating a system comprising an information carrier (10a-g) which is arranged on a vehicle device (12b; 12d; 12f), a tool device (14c), a filter device (15g) or a packaging device (16a; 16e) of a vehicle device (12a), a tool device (14a; 14e) or a filter device (15a) and which carries at least one piece of information, the method comprising receiving the piece of information and providing at least one technical service on the basis of said piece of information.

22. An information carrier (10a-g) of a system according to claim 1.

23. A vehicle device (12b; 12d; 12f), comprising an information carrier (10b; 10d; 10f) according to claim 22.

24. A tool device (14c), comprising an information carrier (10c) according to claim 22.

25. A filter device (15g), comprising an information carrier (10g) according to claim 22.

26. A packaging device (16a; 16e), comprising an information carrier (10a; 10e) according to claim 22.

27. The system according to claim 1, characterized in that the information carrier (10a-e; 10g) comprises a bar code (24a; 24c; 24e; 24g) and/or a 2D code (26b; 26d).

28. The system according to claim 1, characterized in that the unit (18a-g) is a tablet computer and/or a smartphone (32a-g).
